(19) United States
(12) Patent Application Publication
(10) Pub. No.: US 2024/0067426 A1
(43) Pub. Date: Feb. 29, 2024

(54) CONTAINER COMPRISING FIBERS AND METHOD FOR COATING A CONTAINER

(71) Applicant: Krones AG, Neutraubling (DE)

(72) Inventors: Thomas ALBRECHT, Beilngries (DE); Martina BIRK, Bach (DE); Patrick ENGELHARD, Elsendorf (DE); Sandra BREITSCHAEDEL, Regensburg (DE); Angelika GROSSER, Emmerting (DE); Jörg ZACHARIAS, Köfering (DE); Michael NEUBAUER, Grassau (DE); Matthias WAHL, Langquaid (DE); Frank WINZINGER, Regensburg (DE); Ulrich LAPPE, Neutraubling (DE)

(21) Appl. No.: 18/452,971

(22) Filed: Aug. 21, 2023

(30) Foreign Application Priority Data
Aug. 25, 2022 (DE) 10 2022 121 473.7

(51) Int. Cl. B65D 65/42; B65D 1/02; B65D 65/46

(52) U.S. Cl. CPC B65D 65/42; B65D 1/0215; B65D 1/0246; B65D 65/466

(57) ABSTRACT

The disclosure relates to a container comprising fibers, wherein the container further comprises a coating that is biodegradable. The disclosure further relates to a method for coating a container comprising fibers for producing the container.

### CROSS REFERENCE TO RELATED APPLICATION

The present application claims priority to German Patent Application No. 10 2022 121 473.7 filed on Aug. 25, 2022. The entire contents of the above-listed application are hereby incorporated by reference for all purposes.

### TECHNICAL FIELD

The disclosure relates to a container comprising fibers and to a method for producing a container.

### BACKGROUND

At present, after the production process for pulp bottles, a coating of the inner and/or outer side is required before the pulp bottles are supplied for further use. In general, different polymer coatings are used for this purpose, said coatings having been approved for coming into contact with foodstuffs. The material mixture is unfavorable for recycling the pulp bottles and is not biodegradable either.

### SUMMARY

### Problem

The problem addressed by the disclosure is that of providing a container comprising fibers and a method for producing a container, wherein the container guarantees barrier properties and is biodegradable.

### Solution

The problem is solved by the fiber material for producing a container, the method for producing a container, and the container comprising the fiber material as described herein.

The container according to the disclosure comprises fibers, wherein the container further comprises a coating that is biodegradable.

This allows the container to be handled easily after its useful life.

The container with the coating can also be referred to as a coated container and a container to which a coating is first applied, and the container by itself can be referred to as a container.

The fibers can comprise wood and/or cellulose fibers. For the production of the container, the fibers can be provided in a fiber-containing fluid mass which can, for example, be or comprise pulp. The fluid portion of the mass can comprise water.

The coating can comprise an egg membrane. The egg membrane ensures a long shelf life for eggs and, with the high number of processed eggs, the egg membrane separated from the eggshell can be used as a coating.

The coating can comprise a biodegradable biopolymer, for example polyhydroxyalkanoate. A thread region can be reinforced using the biodegradable biopolymer if, for example, the thread is coated from the outside.

The coating can comprise microfibrillated cellulose. Microfibrillated cellulose can be produced by homogenization of cellulose at high pressure and high temperature. The homogenization can take place by grinding or ultrasound. A coating with microfibrillated cellulose can stabilize the container.

The coating can comprise wax, gel coating, sugar coating, pomace skin, orange zest, natural gut, natural stomach, collagen casing and/or rubber. The gel coating and sugar coating can be provided for an inner coating of the container. Pomace skin and orange zest can have sealing effects.

The coating can be applied to an inner surface of the container and/or an outer surface of the container and/or an outer surface of a thread of the container.

A coating on the outer surface can protect the container against moisture entering from the outside and/or oxygen permeating it from the surrounding environment. A coating on the inner surface can protect against a loss of water vapor, carbon dioxide and/or nitrogen or the like from the container into the surrounding environment. This can be useful, for example, if product is located in the coated container and is intended to be or remain shelf-stable up to the point of use.

A thread of the container can comprise microfibrillated cellulose. The microfibrillated cellulose can stabilize the thread.

A method for coating a container comprising fibers for producing the container as described above or below involves applying the coating that is biodegradable.

The coating can be or comprise the coating as described above or below.

The application can involve applying an egg membrane.

The application can involve applying a biodegradable biopolymer, for example polyhydroxyalkanoate.

The application can involve applying microfibrillated cellulose.

The application can involve applying wax, gel coating, sugar coating, pomace skin, orange zest, natural gut, natural stomach, collagen casing and/or rubber.

The application can be carried out on an inner surface of the container and/or an outer surface of the container and/or an outer surface of a thread of the container.

The application can be carried out by spraying and/or dipping.

The application can be carried out at a temperature in a range of from 50° C. to 60° C.

The method can further involve curing the coating.

A device for applying a biodegradable coating to a container comprising fibers. The biodegradable coating can be a biodegradable coating as described above or below.

### BRIEF DESCRIPTION OF THE FIGURES

The accompanying figures show, by way of example, aspects and/or embodiments of the disclosure for better understanding and illustration. In the figures:

FIG. 1 shows a first embodiment of a coated container with a biodegradable coating on the inner surface,

FIG. 2 shows a second embodiment of a coated container with a biodegradable coating on the outer surface of the container and the outer surface of the thread of the container,

FIG. 3 shows a third embodiment of a coated container with a biodegradable coating on the inside of the outer surface of the container, and

FIG. 4 shows a fourth embodiment of a coated container with a biodegradable coating on the outer surface of the thread of the container.

### DETAILED DESCRIPTION

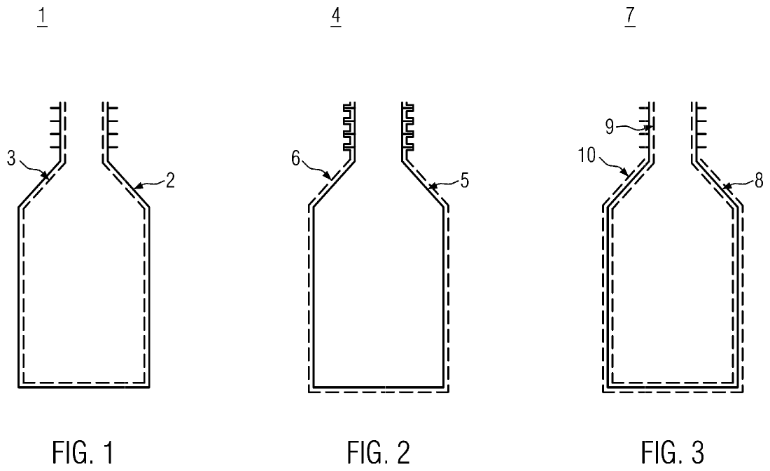

FIG. 1 shows a first embodiment of a coated container 1 with a biodegradable coating 3 on the inner surface of the container 2. The coating 3 on the inner surface of the container 2 can protect against a loss of water vapor, carbon dioxide and/or nitrogen or the like from the container into the surrounding environment, for example when product is located in the coated container 1 and is intended to be or remain shelf-stable up to the point of use. For example, the coating can comprise a biodegradable biopolymer, for example polyhydroxyalkanoate, and/or the coating can comprise wax, gel coating, sugar coating, pomace skin, orange zest, natural gut, natural stomach, collagen casing and/or rubber, or the coating can comprise microfibrillated cellulose.

FIG. 2 shows a second embodiment of a coated container 4 with a biodegradable coating 6 on the outer surface of the container 5 and the outer surface of the thread of the container 5. The coating on the outer surfaces can protect the coated container against moisture entering from the outside and/or oxygen permeating it from the surrounding environment. This can be useful, for example, if product is located in the coated container 4 and is intended to be or remain shelf-stable up to the point of use. The thread can be stabilized by said thread being coated. The biodegradable coating 6 can comprise the types already mentioned with respect to FIG. 1.

FIG. 3 shows a third embodiment of a coated container 7 with a biodegradable coating 9 on the inner surface and a coating 10 on the outer surface of the container 8. The outer surface of the thread is not coated in this instance. Since the inner surface of the container 7 is coated, barrier properties can also be guaranteed in the region of the thread. In the closed state, a lid can be applied to the thread such that the thread can be protected against outside influences, even if the outer surface of the thread itself does not have a coating. The biodegradable coating 6 can comprise the types already mentioned with respect to FIG. 1.

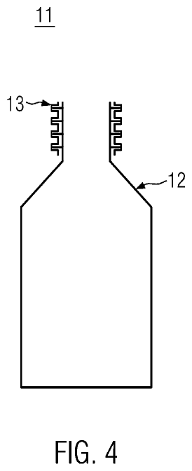

FIG. 4 shows a fourth embodiment of a coated container 11 with a biodegradable coating 13 on the outer surface of the thread of the container 12. The biodegradable coating 6 can comprise the types already mentioned with respect to FIG. 1.

For example, a biodegradable biopolymer can be used as a biodegradable coating 13 to reinforce the thread region. The thread region can be or comprise the region which is coated.

For example, the thread can be stabilized with a coating 13 of microfibrillated cellulose.

1. Container comprising fibers, wherein the container further comprises a coating that is biodegradable.

2. Container according to claim 1, wherein the coating comprises an egg membrane.

3. Container according to claim 1, wherein the coating comprises a biodegradable biopolymer, for example polyhydroxyalkanoate.

4. Container according to claim 1, wherein the coating comprises microfibrillated cellulose.

5. Container according to claim 1, wherein the coating comprises: wax, gel coating, sugar coating, pomace skin, orange zest, natural gut, natural stomach, collagen casing and/or rubber.

6. Container according to claim 1, wherein the coating is applied to an inner surface of the container and/or an outer surface of the container and/or an outer surface of a thread of the container.

7. Container according to claim 1, wherein a thread of the container comprises microfibrillated cellulose.

8. Method for coating a container comprising fibers for producing the container according to claim 1, wherein the method involves:
applying the coating that is biodegradable.

9. Method according to claim 8, wherein the application involves applying an egg membrane.

10. Method according to claim 8, wherein the application involves applying a biodegradable biopolymer.

11. Method according to claim 8, wherein the application involves applying microfibrillated cellulose.

12. Method according to claim 9, wherein the application is carried out on an inner surface of the container and/or an outer surface of the container and/or an outer surface of a thread of the container.

13. Method according to claim 8, wherein the application is carried out by spraying and/or dipping.

14. Method according to claim 8, wherein the application is carried out at a temperature in a range of from 50° C. to 60° C.

15. Method according to claim 8, further involving curing the coating.
